(19) United States
(12) Patent Application Publication
(10) Pub. No.: US 2024/0152312 A1
(43) Pub. Date: May 9, 2024

(54) SECURING CRITICAL AUDIO PATHS

(71) Applicant: QUALCOMM Incorporated, San Diego, CA (US)

(72) Inventors: Chetan Rajashekhar PACHAPUR, Bangalore (IN); Krishna KISHOR JHA, Bangalore (IN)

(21) Appl. No.: 18/053,207

(22) Filed: Nov. 7, 2022

(51) Int. Cl. G06F 3/16

(52) U.S. Cl. CPC G06F 3/162

(57) ABSTRACT

In some aspects, an audio digital signal processor (DSP) may receive a request for an audio session. The audio DSP may transmit an indication of an assigned audio session identity based at least in part on whether the request for the audio session is associated with a critical audio path. Additionally, or alternatively, a time division multiplex (TDM) block may receive a request for an audio channel. The TDM block may transmit an indication of an assigned audio port based at least in part on whether the request for the audio channel is associated with a critical audio path. Additionally, or alternatively, codec hardware may receive a request for an audio pin. The codec hardware may transmit an indication of an assigned hardware pin based at least in part on whether the request for the audio pin is associated with a critical audio path. Numerous other aspects are described.

### FIELD OF THE DISCLOSURE

Aspects of the present disclosure generally relate to audio generation and, for example, to securing critical audio paths.

### BACKGROUND

For audio playback, an audio chain usually includes a digital signal processor (DSP) to generate digital output signals based on an input file or another type of digital input from an audio source. Further, the DSP will transmit the output signals to a time division multiplex (TDM) block, which may be part of a digital-to-analog converter (DAC), for conversion to analog signals and possible combination with additional signals (e.g., from other audio sessions processed by the DSP). The TDM block (e.g., via a bus of the DAC) may transmit the analog signals to a codec, and the codec may generate analog commands for an audio speaker to output audio waves corresponding to the input from the audio source.

### SUMMARY

Some aspects described herein relate to an apparatus for audio generation at an audio digital signal processor (DSP). The apparatus may include a memory and one or more processors coupled to the memory. The one or more processors may be configured to receive a request for an audio session. The one or more processors may be configured to transmit an indication of an assigned audio session identity (ID) based at least in part on whether the request is associated with a critical audio path.

Some aspects described herein relate to an apparatus for audio generation at a time division multiplex (TDM) block. The apparatus may include a memory and one or more processors coupled to the memory. The one or more processors may be configured to receive a request for an audio channel. The one or more processors may be configured to transmit an indication of an assigned audio port based at least in part on whether the request is associated with a critical audio path.

Some aspects described herein relate to an apparatus for audio generation at codec hardware. The apparatus may include a memory and one or more processors coupled to the memory. The one or more processors may be configured to receive a request for an audio channel. The one or more processors may be configured to transmit an indication of an assigned hardware pin based at least in part on whether the request is associated with a critical audio path.

Some aspects described herein relate to an apparatus for audio generation at an audio system. The apparatus may include a memory and one or more processors coupled to the memory. The one or more processors may be configured to receive, at an audio DSP, a request for an audio session. The one or more processors may be configured to transmit, by the audio DSP, an indication of an assigned audio session ID based at least in part on whether the request for the audio session is associated with a critical audio path. The one or more processors may be configured to receive, at a TDM block, a request for an audio channel. The one or more processors may be configured to transmit, by the TDM block, an indication of an assigned audio port based at least in part on whether the request for the audio channel is associated with a critical audio path. The one or more processors may be configured to receive, at codec hardware, a request for an audio pin. The one or more processors may be configured to transmit, by the codec hardware, an indication of an assigned hardware pin based at least in part on whether the request for the audio pin is associated with a critical audio path.

Some aspects described herein relate to a method performed by an audio DSP. The method may include receiving a request for an audio session. The method may include transmitting an indication of an assigned audio session ID based at least in part on whether the request is associated with a critical audio path.

Some aspects described herein relate to a method performed by a TDM block. The method may include receiving a request for an audio channel. The method may include transmitting an indication of an assigned audio port based at least in part on whether the request is associated with a critical audio path.

Some aspects described herein relate to a method performed by codec hardware. The method may include receiving a request for an audio channel. The method may include transmitting an indication of an assigned hardware pin based at least in part on whether the request is associated with a critical audio path.

Some aspects described herein relate to a method performed by an audio system. The method may include receiving, at an audio DSP, a request for an audio session. The method may include transmitting, by the audio DSP, an indication of an assigned audio session ID based at least in part on whether the request for the audio session is associated with a critical audio path. The method may include receiving, at a TDM block, a request for an audio channel. The method may include transmitting, by the TDM block, an indication of an assigned audio port based at least in part on whether the request for the audio channel is associated with a critical audio path. The method may include receiving, at codec hardware, a request for an audio pin. The method may include transmitting, by the codec hardware, an indication of an assigned hardware pin based at least in part on whether the request for the audio pin is associated with a critical audio path.

Some aspects described herein relate to a non-transitory computer-readable medium that stores a set of instructions for audio generation by an audio DSP. The set of instructions, when executed by one or more processors of the audio DSP, may cause the audio DSP to receive a request for an audio session. The set of instructions, when executed by one or more processors of the audio DSP, may cause the audio DSP to transmit an indication of an assigned audio session ID based at least in part on whether the request is associated with a critical audio path.

Some aspects described herein relate to a non-transitory computer-readable medium that stores a set of instructions for audio generation by a TDM block. The set of instructions, when executed by one or more processors of the TDM block, may cause the TDM block to receive a request for an audio channel. The set of instructions, when executed by one or more processors of the TDM block, may cause the TDM block to transmit an indication of an assigned audio port based at least in part on whether the request is associated with a critical audio path.

Some aspects described herein relate to a non-transitory computer-readable medium that stores a set of instructions for wireless communication by codec hardware. The set of instructions, when executed by one or more processors of the codec hardware, may cause the codec hardware to receive a request for an audio channel. The set of instructions, when executed by one or more processors of the codec hardware, may cause the codec hardware to transmit an indication of an assigned hardware pin based at least in part on whether the request is associated with a critical audio path.

Some aspects described herein relate to a non-transitory computer-readable medium that stores a set of instructions for audio generation by an audio system. The set of instructions, when executed by one or more processors of the audio system, may cause the audio system to receive, at an audio DSP, a request for an audio session. The set of instructions, when executed by one or more processors of the audio system, may cause the audio system to transmit an indication of an assigned audio session ID based at least in part on whether the request for the audio session is associated with a critical audio path. The set of instructions, when executed by one or more processors of the audio system, may cause the audio system to receive, at a TDM block, a request for an audio channel. The set of instructions, when executed by one or more processors of the audio system, may cause the audio system to transmit an indication of an assigned audio port based at least in part on whether the request for the audio channel is associated with a critical audio path. The set of instructions, when executed by one or more processors of the audio system, may cause the audio system to receive, at codec hardware, a request for an audio pin. The set of instructions, when executed by one or more processors of the audio system, may cause the audio system to transmit an indication of an assigned hardware pin based at least in part on whether the request for the audio pin is associated with a critical audio path.

Some aspects described herein relate to an apparatus for wireless communication. The apparatus may include means for receiving a request for an audio session. The apparatus may include means for transmitting an indication of an assigned audio session ID based at least in part on whether the request is associated with a critical audio path.

Some aspects described herein relate to an apparatus for wireless communication. The apparatus may include means for receiving a request for an audio channel. The apparatus may include means for transmitting an indication of an assigned audio port based at least in part on whether the request is associated with a critical audio path.

Some aspects described herein relate to an apparatus for wireless communication. The apparatus may include means for receiving a request for an audio channel. The apparatus may include means for transmitting an indication of an assigned hardware pin based at least in part on whether the request is associated with a critical audio path.

Some aspects described herein relate to an apparatus for wireless communication. The apparatus may include means for receiving, at an audio DSP, a request for an audio session. The apparatus may include means for transmitting an indication of an assigned audio session ID based at least in part on whether the request for the audio session is associated with a critical audio path. The apparatus may include means for receiving, at a TDM block, a request for an audio channel. The apparatus may include means for transmitting an indication of an assigned audio port based at least in part on whether the request for the audio channel is associated with a critical audio path. The apparatus may include means for receiving, at codec hardware, a request for an audio pin. The apparatus may include means for transmitting an indication of an assigned hardware pin based at least in part on whether the request for the audio pin is associated with a critical audio path.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which secure critical audio paths described herein may be implemented, in accordance with the present disclosure.

FIG. 2 is a diagram illustrating example components of one or more devices shown in FIG. 1, such as an audio output device, in accordance with the present disclosure.

FIGS. 3A-3B are diagrams illustrating an example associated with securing critical audio paths, in accordance with the present disclosure.

FIGS. 4A-4B are diagrams illustrating an example associated with securing critical audio paths, in accordance with the present disclosure.

FIGS. 5A-5B are diagrams illustrating an example associated with securing critical audio paths, in accordance with the present disclosure.

FIGS. 6, 7, and 8 are flowcharts of example processes associated with securing critical audio paths, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An output audio chain may include a digital signal processor (DSP) configured to generate digital output based on digital input from an audio source. The audio source may include a host system and/or a user device (e.g., connected to the host system, whether through a wired connection and/or a wireless connection). The DSP may perform mathematical operations (e.g., multiply-and-accumulate (MAC) operations or other similar arithmetic operations) on the digital input to generate the digital output. The DSP may transmit the digital output to a time division multiplex (TDM) block (e.g., a hardware and/or software portion of a digital-to-analog converter (DAC)) for conversion to analog signals. The TDM block may additionally combine digital outputs from the DSP associated with multiple audio sessions. The TDM block (e.g., via a bus of the DAC) may transmit the analog signals to a codec. The codec may include hardware or a combination of hardware and software, and the codec may generate analog commands to cause an audio speaker to output audio waves that correspond to the digital input from the audio source.

Many audio systems permit external devices (e.g., user devices) to use one or more speakers for audio playback. For example, an infotainment system of a vehicle may receive input from an external device (e.g., using Bluetooth®) and process the input to play over the speaker(s). In some implementations, the infotainment system may authorize an operating system (OS) of the external device to access an audio chain of the infotainment system directly. Alternatively, the infotainment system may receive the input at an OS of the infotainment system, which in turn provides the input to the audio chain.

Some audio from a host system may be critical as compared with other audio from the host system and/or audio from an external device. For example, some audio may be associated with an advanced driving assistance system (ADAS), a fully automated driving system, or an emergency alert system, among other examples. However, bad actors may use the external device or infiltrate the host system in order to override critical audio. In addition to reducing safety, overriding critical audio may waste power and processing resource at the audio chain. For example, bad actors may needlessly occupy audio session identities (IDs), audio channels, and/or audio pins in order to override critical audio.

Some implementations described herein enable a DSP, a TDM block, and/or a codec of an audio chain to reserve audio session IDs, audio channels, and/or audio pins, respectively, for critical audio paths. As a result, power and processing resources are conserved because bad actors are prevented from needlessly occupying audio session IDs, audio channels, and/or audio pins in order to override critical audio. Additionally, safety is improved because the critical audio is not overridden.

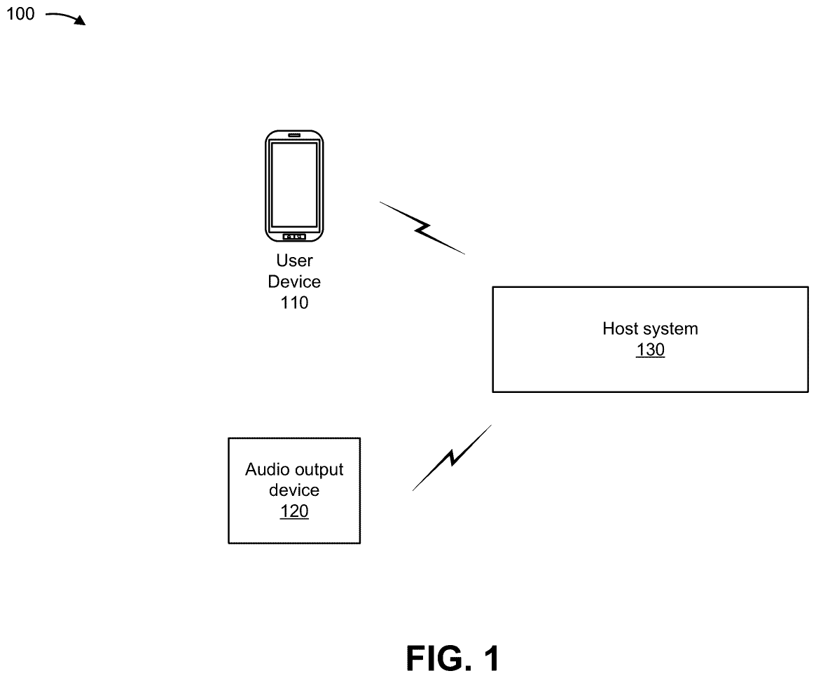

FIG. 1 is a diagram of an example environment 100 in which systems and/or methods described herein may be implemented. As shown in FIG. 1, environment 100 may include a user device 110, an audio output device 120, and a host system 130. Devices of environment 100 may interconnect via wired connections, wireless connections, or a combination of wired and wireless connections.

The user device 110 may include one or more devices capable of receiving, generating, storing, processing, and/or providing information associated with audio, as described elsewhere herein. The user device 110 may include a communication device and/or a computing device. For example, the user device 110 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The audio output device 120 may include one or more devices capable of receiving, generating, storing, processing, and/or providing information associated with audio, as described elsewhere herein. The audio output device 120 may include an audio chain and at least one speaker configured to generate audio waves based on information input to the audio output device 120. The audio output device 120 may be at least partially integrated (e.g., physically, logically, and/or virtually) with the host system 130. Accordingly, an OS of the host system 130 may control the audio output device 120 and provide input thereto. In some implementations, the host system 130 may allow the user device 110 to control the audio output device 120 and provide input thereto.

The host system 130 may include one or more devices capable of receiving, generating, storing, processing, and/or providing information associated with audio, as described elsewhere herein. The host system 130 may include a communication device and/or a computing device. For example, the host system 130 may include an infotainment system (e.g., of a vehicle), a stereo system, a pair of headphones (whether wired or wireless), or a similar type of device. The host system 130 may implement an OS to control the hardware of the host system 130 and hardware associated therewith (e.g., the audio output device 120).

The user device 110 may communicate with the host system 130 over one or more wired and/or wireless networks. For example, the user device 110 and the host system 130 may communicate over a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

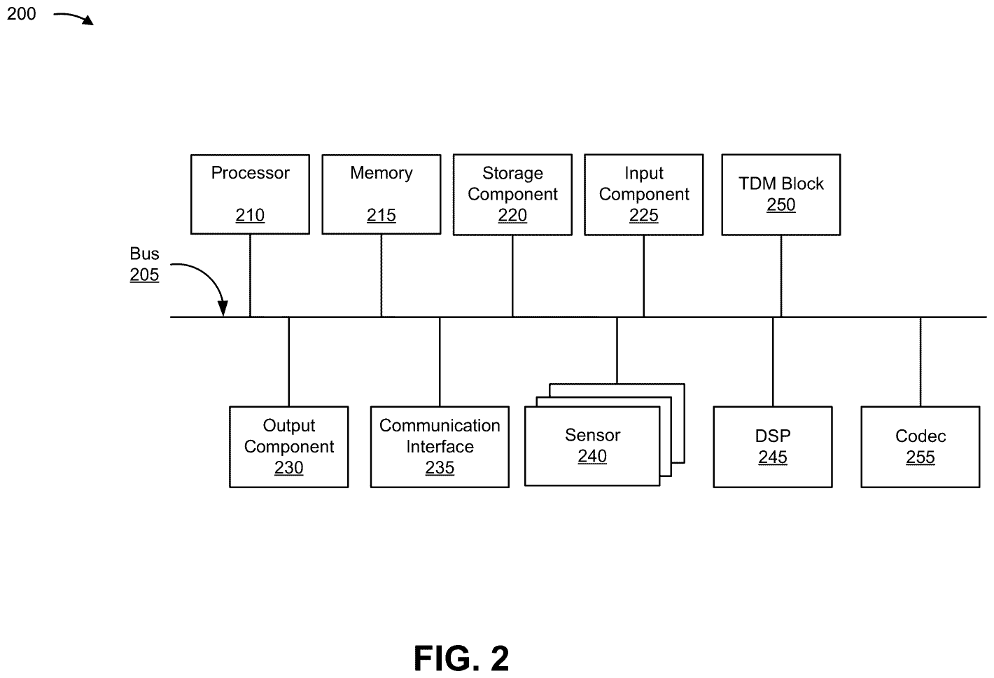

FIG. 2 is a diagram illustrating example components of a device 200, in accordance with the present disclosure. Device 200 may correspond to a user device 110, an audio output device 120, and/or a host system 130. In some aspects, the user device 110, the audio output device 120, and/or the host system 130 may include one or more devices 200 and/or one or more components of device 200. As shown in FIG. 2, device 200 may include a bus 205, a processor 210, a memory 215, a storage component 220, an input component 225, an output component 230, a communication interface 235, one or more sensors 240, a DSP 245, a TDM block 250, and/or a codec 255.

Bus 205 includes a component that permits communication among the components of device 200. Processor 210 is implemented in hardware, firmware, or a combination of hardware and software. Processor 210 is a central processing unit (CPU), a graphics processing unit (GPU), an accelerated processing unit (APU), a microprocessor, a microcontroller, a DSP, a field-programmable gate array (FPGA), an application-specific integrated circuit (ASIC), or another type of processing component. In some aspects, processor 210 includes one or more processors capable of being programmed to perform a function. Memory 215 includes a random access memory (RAM), a read only memory (ROM), and/or another type of dynamic or static storage device (e.g., a flash memory, a magnetic memory, and/or an optical memory) that stores information and/or instructions for use by processor 210.

Storage component 220 stores information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 includes a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 includes a component that provides output information from device 200 (e.g., a display, a speaker, a haptic feedback component, and/or an audio or visual indicator).

Communication interface 235 includes a transceiver-like component (e.g., a transceiver and/or a separate receiver and transmitter) that enables device 200 to communicate with other devices, such as via a wired connection, a wireless connection, or a combination of wired and wireless connections. Communication interface 235 may permit device 200 to receive information from another device and/or provide information to another device. For example, communication interface 235 may include an Ethernet interface, an optical interface, a coaxial interface, an infrared interface, a radio frequency interface, a universal serial bus (USB) interface, a wireless local area interface (e.g., a Wi-Fi interface), and/or a cellular network interface.

Sensor(s) 240 include one or more devices that perform measurements on an environment of the device 200. For example, sensor(s) 240 may include an accelerometer, a gravitometer, a magnetometer, a compass, an inertial measurement unit (IMU), a pressure sensor, a barometer, and/or a thermometer, among other examples. Sensor(s) 240 may additionally or alternatively include a location sensor, such as a GPS sensor or another type of GNSS sensor.

DSP 245 includes a special-purpose processor configured to perform mathematical functions for decoding digital input into digital audio signals. For example, DSP 245 may include an integrated circuit (IC), an FPGA, and/or another type of processor that is programmed (e.g., at least in part via hardware) to perform MAC operations and/or other types of arithmetic operations for audio processing.

TDM block 250 includes a time division multiplexer that processes digital audio signals from the DSP 245. In some implementations, the TDM block 250 is at least partially integrated with a DAC. Alternatively, the TDM block 250 and the DAC may communicate over one or more interfaces therebetween.

Codec 255 includes hardware (or a combination of hardware and software) configured to process analog audio signals into commands for a speaker. For example, codec 255 may include an IC and/or another type of special-purpose processor that is programmed (e.g., at least in part via hardware) to control the speaker (e.g., over a bus) according to analog input.

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication interface 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, device 200 includes means for performing one or more processes described herein and/or means for performing one or more operations of the processes described herein. For example, device 200 may include means for receiving a request for an audio session; means for transmitting an indication of an assigned audio session ID based at least in part on whether the request is associated with a critical audio path; means for receiving a request for an audio channel; means for transmitting an indication of an assigned audio port based at least in part on whether the request is associated with a critical audio path; and/or means for transmitting an indication of an assigned hardware pin based at least in part on whether the request is associated with a critical audio path. In some aspects, such means may include one or more components of device 200 described in connection with FIG. 2, such as bus 205, processor 210, memory 215, storage component 220, input component 225, output component 230, communication interface 235, the sensor(s) 240, the DSP 245, the TDM block 250, and/or the codec 255.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

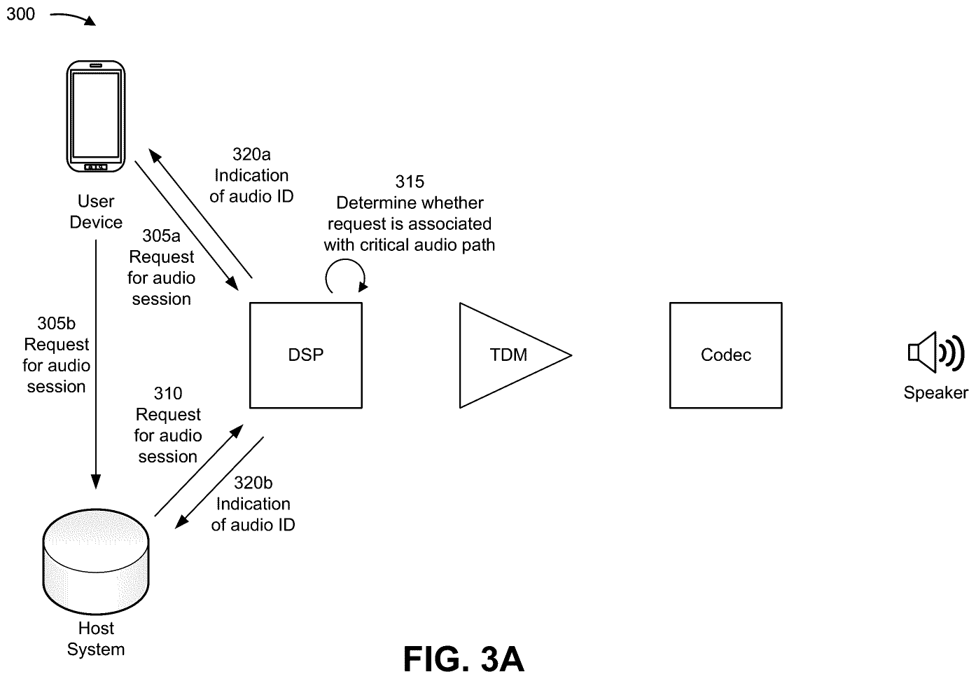

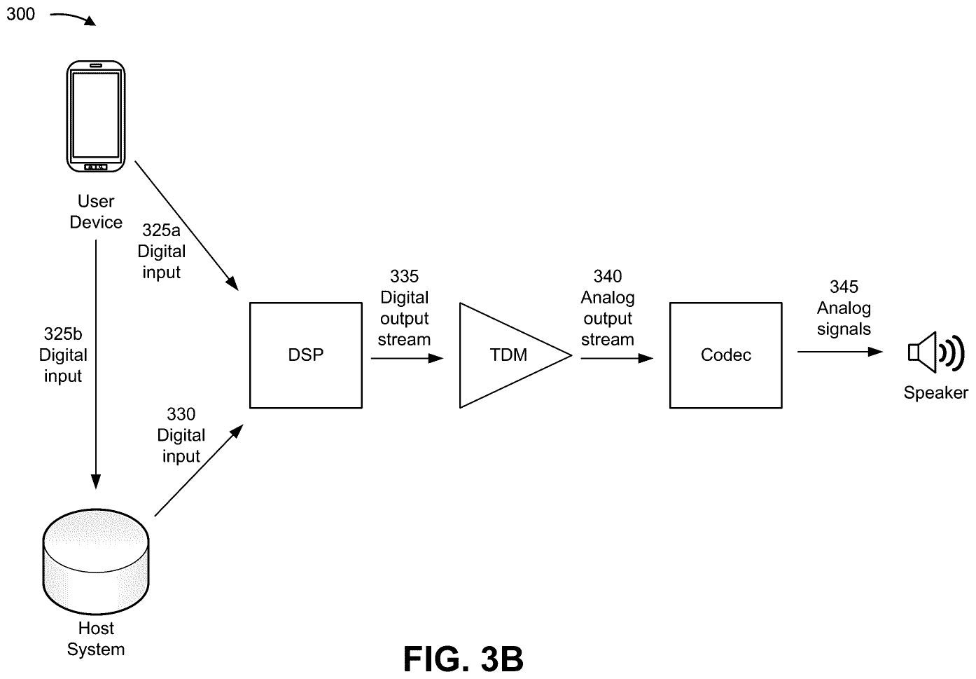

FIGS. 3A-3B are diagrams illustrating an example 300 associated with securing critical audio paths, in accordance with the present disclosure. As shown in FIGS. 3A-3B, example 300 includes a user device in communication with a host system (e.g., over a wired and/or wireless connection). The host system may control an audio chain including a DSP, a TDM block, a codec, and a speaker.

As shown in FIG. 3A and by reference number 305a, the user device may transmit, and the DSP may receive, a request for an audio session. For example, a user may interact with the user device (e.g., via a touchscreen, a mouse, a keyboard, and/or another type of input device) and trigger the user device to play audio. Accordingly, the user device may request an audio session from the DSP in order to play the audio through the speaker associated with the host system. Additionally, or alternatively, an application executed on the user device may buffer audio to an OS of the user device for playback, and the OS may transmit the request in response to detecting the audio in the buffer.

The user device may transmit the request directly to the DSP (e.g., when the host system provides the OS of the user device access to the DSP). Alternatively, as shown by reference number 305b, the user device may transmit, and the host system may receive, the request for the audio session. Accordingly, the host system may transmit, and the DSP may receive, a request for an audio session based on the request from the user device, as shown by reference number 310. The host system may forward the request from the user device or may generate a new request for transmitting to the DSP using information included in the request from the user device.

Additionally, or alternatively, the host system may transmit, and the DSP may receive, a request for an audio session for the host system. For example, the user may interact with the host system (e.g., via a touchscreen, a mouse, a keyboard, and/or another type of input device) and trigger the host system to play audio. Accordingly, the host system may request an audio session from the DSP in order to play the audio through the speaker. Additionally, or alternatively, an application executed on the host system may buffer audio for playback, and an OS of the host system may transmit the request in response to detecting the audio in the buffer.

As shown by reference number 315, the DSP may determine whether the request for the audio session is associated with a critical audio path. For example, the request may be associated with ADAS audio, fully automated driving system audio, an emergency alert system audio, or another type of critical audio that should not be overridden. Alternatively, the request may be associated with radio audio (e.g., a satellite radio, a frequency modulation (FM) radio, or an amplitude modulation (AM) radio), an audio application (e.g., Spotify®, Audible®, or another type of application executed by the user device and/or the host system that buffers entertainment audio), or a navigation application (e.g., Waze®, Apple® Maps, or another type of application executed by the user device and/or the host system that buffers navigation directions), among other examples.

In some implementations, the DSP may determine whether the request is associated with a critical audio path based at least in part on a source associated with the request. For example, the DSP may determine that audio from the host system is critical while audio from the user device is not. Additionally, or alternatively, the DSP may determine whether the request is associated with a critical audio path based at least in part on a flag associated with the request. For example, the request may include at least one bit that indicates whether the request is critical. Additionally, or alternatively, the DSP may determine whether the request is associated with a critical audio path based at least in part on a key associated with the request. For example, the request may include a sequence (or another type of data) that is generated using a private key. Accordingly, the host system may use the private key to generate the sequence and thus indicate when the request is critical. Because external devices like the user device do not have the key, the user device is unable to generate the sequence. Any of the factors described above may be combined. For example, the DSP may determine that the request is associated with a critical audio path when the source is the host system and when the request includes the flag.

As shown by reference number 320a, the DSP may transmit, and the user device may receive, an indication of an assigned audio session ID based at least in part on whether the request is associated with a critical audio path. For example, the DSP may reserve a first set of audio session IDs for critical audio paths while a second set of audio session IDs may be used for other audio paths. The first set of audio session IDs and the second set of audio session IDs may be preconfigured (e.g., hard-wired or otherwise programmed into the DSP). Alternatively, the DSP may dynamically reserve the first set of audio session IDs and assign remaining audio session IDs to the second set of audio session IDs. For example, the DSP may receive input from the host system indicating a quantity of critical audio paths and reserve the first set of audio session IDs based on the quantity. In some implementations, the first set of audio session IDs may be further selected based on a floor (e.g., always having at least one, two, or more audio session IDs reserved for critical audio) and/or a ceiling (e.g., having no more than three, four, or more audio session IDs reserved for critical audio).

Accordingly, the DSP may select the assigned audio session ID from the first set of audio session IDs when the request is critical and may select the assigned audio session ID from the second set of audio session IDs when the request is not critical.

The user device may receive the audio session ID directly from the DSP (e.g., when the host system provides the OS of the user device access to the DSP). Alternatively, as shown by reference number 320b, the DSP may transmit, and the host system may receive, audio session ID. Accordingly, the host system may transmit, and the user device may receive, an indication of the audio session ID. The host system may forward a packet indicating audio session ID from the DSP or may generate a new packet for transmitting to the user device indicating the audio session ID.

As shown in FIG. 3B and by reference number 325a, the user device may transmit, and the DSP may receive, input associated with the assigned audio session ID. For example, the OS of, or an application executed on, the user device may buffer audio for playback, and the OS of the user device may transmit the input (e.g., digitally encoding the buffered audio) in response to detecting the audio in the buffer.

The user device may transmit the input directly to the DSP (e.g., when the host system provides the OS of the user device access to the DSP). Alternatively, as shown by reference number 325b, the user device may transmit, and the host system may receive, the input associated with the assigned audio session ID. Accordingly, the host system may transmit, and the DSP may receive, digital input based on the input from the user device, as shown by reference number 330. The host system may forward the input from the user device or may generate new packets for transmitting to the DSP using information included in the input from the user device.

Additionally, or alternatively, the host system may transmit, and the DSP may receive, input associated with the assigned audio session ID. For example, the OS of, or an application executed on, the host system may buffer audio for playback, and the OS of the host system may transmit the input (e.g., digitally encoding the buffered audio) in response to detecting the audio in the buffer.

As shown by reference number 335, the DSP may process the input (from the user device and/or the host system) to generate a digital output stream (comprising output signals) and transmit the digital output stream to the TDM block. Further, as shown by reference number 340, the TDM block may combine digital output streams from the DSP, process the combined streams to generate an analog output stream (comprising an output audio stream), and transmit the analog output stream to the codec. As shown by reference number 345, the codec may decode the analog output stream to generate output analog signals and transmit the output analog signals to the speaker, which will generate audio waves from the output analog signals.

By using techniques as described in connection with FIGS. 3A-3B, security is increased because critical audio paths are protected by the DSP. As a result, power and processing resources at the audio chain are conserved because bad actors are prevented from needlessly occupying audio session IDs in order to override critical audio.

As indicated above, FIGS. 3A-3B are provided as an example. Other examples may differ from what is described with respect to FIGS. 3A-3B.

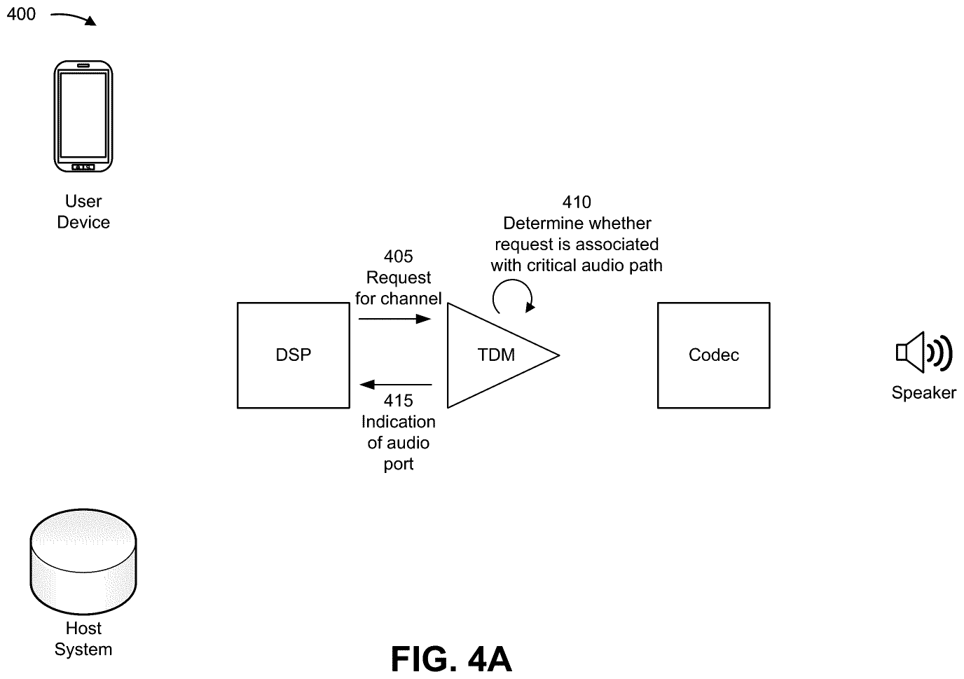

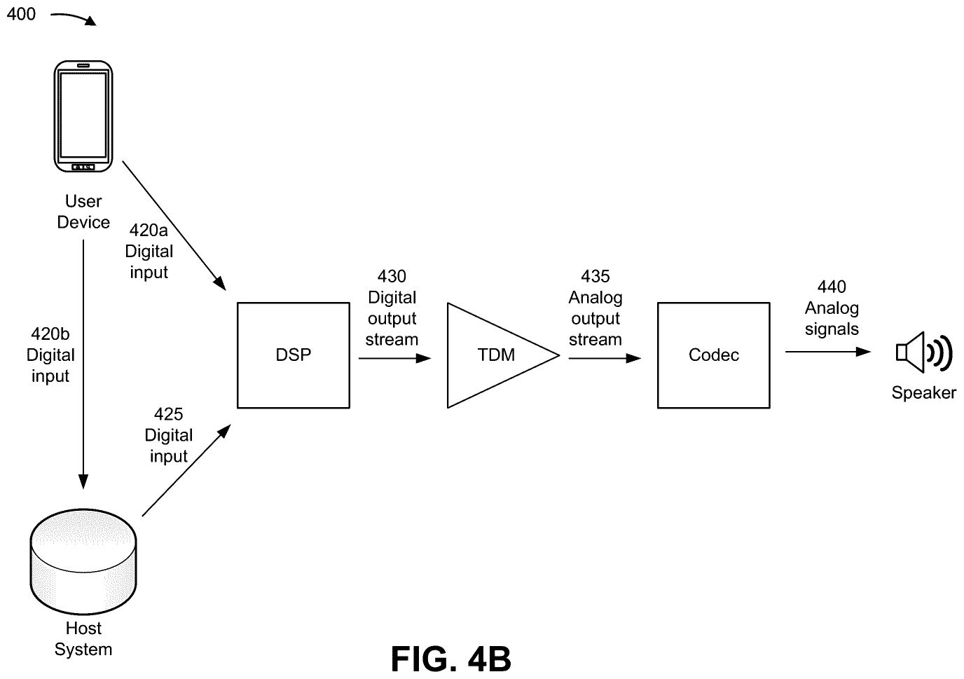

FIGS. 4A-4B are diagrams illustrating an example 400 associated with securing critical audio paths, in accordance with the present disclosure. As shown in FIGS. 4A-4B, example 400 includes a user device in communication with a host system (e.g., over a wired and/or wireless connection). The host system may control an audio chain including a DSP, a TDM block, a codec, and a speaker.

As described above in connection with FIGS. 3A-3B, the DSP may assign an audio session ID to the user device or the host system. Additionally, as shown in FIG. 4A and by reference number 405, the DSP may transmit, and the TDM block may receive, a request for an audio channel. For example, the DSP may have input, associated with one or more audio session IDs, to process and output to the TDM block and thus may request the audio channel in order to output processed data, associated with the one or more session IDs, to the TDM block.

As shown by reference number 410, the TDM block may determine whether the request for the audio channel is associated with a critical audio path. For example, the request may be associated with ADAS audio, fully automated driving system audio, an emergency alert system audio, or another type of critical audio that should not be overridden. Alternatively, the request may be associated with radio audio (e.g., a satellite radio, an FM radio, or an AM radio), an audio application (e.g., Spotify, Audible, or another type of application executed by the user device and/or the host system that buffers entertainment audio), or a navigation application (e.g., Waze, Apple Maps, or another type of application executed by the user device and/or the host system that buffers navigation directions), among other examples.

In some implementations, the TDM block may determine whether the request is associated with a critical audio path based at least in part on a source associated with the request. For example, the TDM block may determine that audio associated with some audio session IDs is critical while audio associated with other audio session IDs is not. Additionally, or alternatively, the TDM block may determine whether the request is associated with a critical audio path based at least in part on a flag associated with the request. For example, the request may include at least one bit that indicates whether the request is critical. Additionally, or alternatively, the TDM block may determine whether the request is associated with a critical audio path based at least in part on a key associated with the request. For example, the request may include a sequence (or another type of data) that is generated using a private key. Accordingly, the DSP may use the private key to generate the sequence and thus indicate when the request is critical. Any of the factors described above may be combined. For example, the TDM block may determine that the request is associated with a critical audio path when the source indicates an audio session ID that is critical and when the request includes the flag.

As shown by reference number 415, the TDM block may transmit, and the DSP may receive, an indication of an assigned audio port based at least in part on whether the request is associated with a critical audio path. For example, the TDM block may reserve a first set of audio ports for critical audio paths while a second set of audio ports may be used for other audio paths. The first set of audio ports and the second set of audio ports may be preconfigured (e.g., hard-wired or otherwise programmed into the TDM block). Alternatively, the TDM block may dynamically reserve the first set of audio ports and assign remaining audio ports to the second set of audio ports. For example, the TDM block may receive input from the host system indicating a quantity of critical audio paths and reserve the first set of audio ports based on the quantity. In some implementations, the first set of audio ports may be further selected based on a floor (e.g., always having at least one, two, or more audio ports reserved for critical audio) and/or a ceiling (e.g., having no more than three, four, or more audio ports reserved for critical audio).

Accordingly, the TDM block may select the assigned audio port from the first set of audio ports when the request is critical and may select the assigned audio port from the second set of audio ports when the request is not critical. As shown in FIG. 4B and by reference number 420a, the user device may transmit, and the DSP may receive, input associated with an audio session ID. For example, the OS of, or an application executed on, the user device may buffer audio for playback, and the OS of the user device may transmit the input (e.g., digitally encoding the buffered audio) in response to detecting the audio in the buffer.

The user device may transmit the input directly to the DSP (e.g., when the host system provides the OS of the user device access to the DSP). Alternatively, as shown by reference number 420b, the user device may transmit, and the host system may receive, the input associated with the audio session ID. Accordingly, the host system may transmit, and the DSP may receive, digital input based on the input from the user device, as shown by reference number 425. The host system may forward the input from the user device or may generate new packets for transmitting to the DSP using information included in the input from the user device.

Additionally, or alternatively, the host system may transmit, and the DSP may receive, input associated with the audio session ID. For example, the OS of, or an application executed on, the host system may buffer audio for playback, and the OS of the host system may transmit the input (e.g., digitally encoding the buffered audio) in response to detecting the audio in the buffer.

As shown by reference number 430, the DSP may process the input (from the user device and/or the host system) to generate a digital output stream (comprising output signals) and transmit the digital output stream to the TDM block. Further, as shown by reference number 435, the TDM block may combine digital output streams from the DSP, process the combined streams to generate an analog output stream (comprising an output audio stream), and transmit the analog output stream to the codec. As shown by reference number 440, the codec may decode the analog output stream to generate output analog signals and transmit the output analog signals to the speaker, which will generate audio waves from the output analog signals.

By using techniques as described in connection with FIGS. 4A-4B, security is increased because critical audio paths are protected by the TDM block. As a result, power and processing resources at the audio chain are conserved because bad actors are prevented from needlessly occupying audio ports in order to override critical audio.

As indicated above, FIGS. 4A-4B are provided as an example. Other examples may differ from what is described with respect to FIGS. 4A-4B.

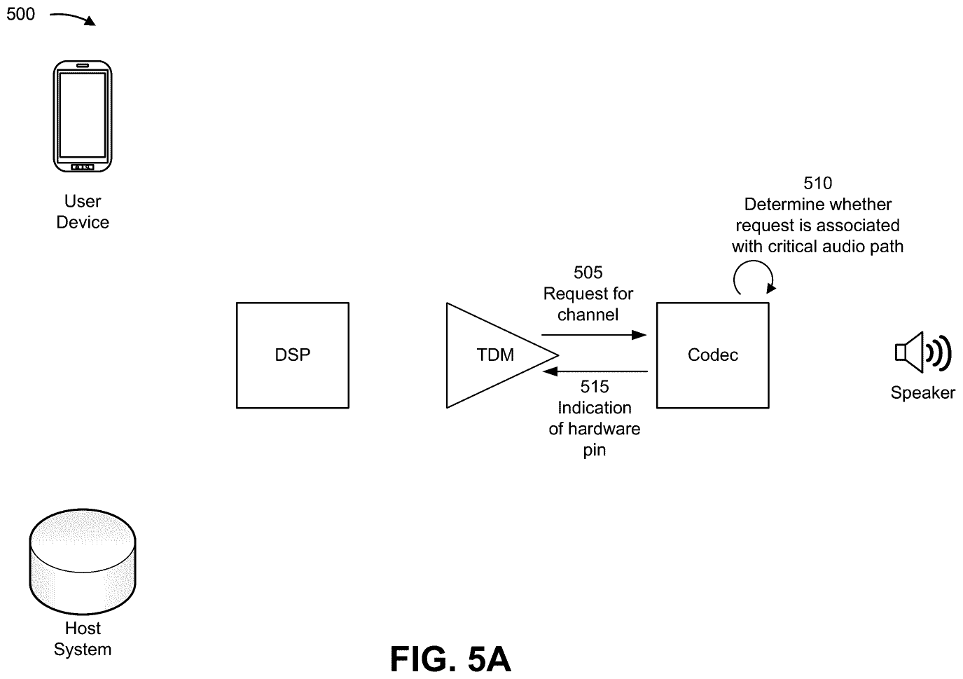

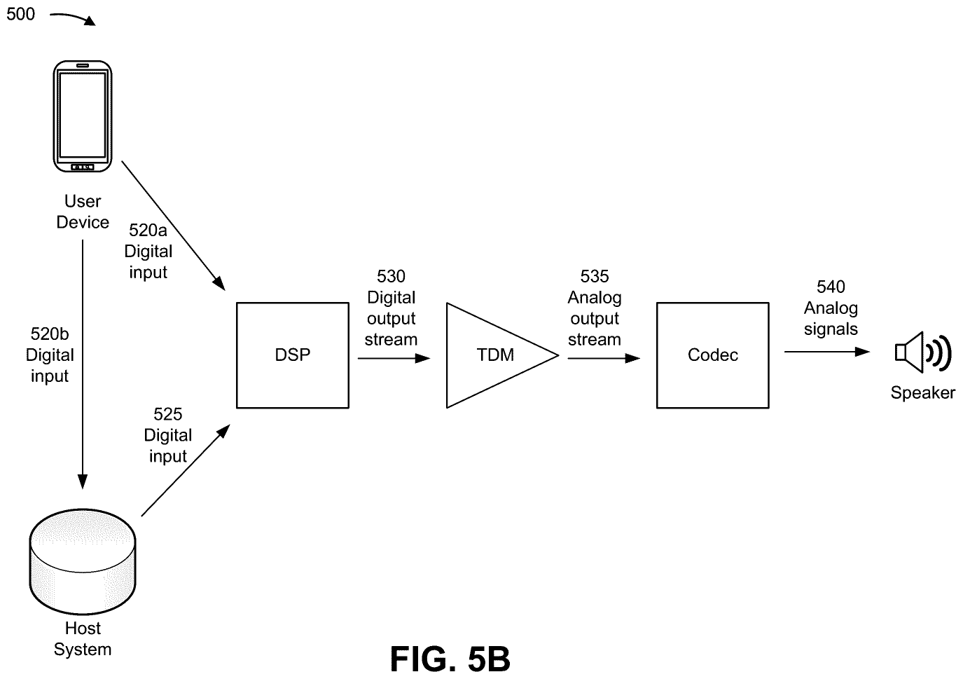

FIGS. 5A-5B are diagrams illustrating an example 500 associated with securing critical audio paths, in accordance with the present disclosure. As shown in FIGS. 5A-5B, example 500 a user device in communication with a host system (e.g., over a wired and/or wireless connection). The host system may control an audio chain including a DSP, a TDM block, a codec, and a speaker.

As described above in connection with FIGS. 3A-3B, the DSP may assign an audio session ID to the user device or the host system. Additionally, as described above in connection with FIGS. 4A-4B, the TDM block may assign an audio port to the DSP. As shown in FIG. 5A and by reference number 505, the TDM block may transmit, and the codec may receive, a request for an audio channel. For example, the TDM block may have input, associated with an audio port, to process and output to the codec and thus may request the audio channel in order to output processed data, associated with the audio port, to the codec.

As shown by reference number 510, the codec may determine whether the request for the audio channel is associated with a critical audio path. For example, the request may be associated with ADAS audio, fully automated driving system audio, an emergency alert system audio, or another type of critical audio that should not be overridden. Alternatively, the request may be associated with radio audio (e.g., a satellite radio, an FM radio, or an AM radio), an audio application (e.g., Spotify, Audible, or another type of application executed by the user device and/or the host system that buffers entertainment audio), or a navigation application (e.g., Waze, Apple Maps, or another type of application executed by the user device and/or the host system that buffers navigation directions), among other examples.

In some implementations, the codec may determine whether the request is associated with a critical audio path based at least in part on a source associated with the request. For example, the codec may determine that audio associated with some audio ports is critical while audio associated with other audio ports is not. Additionally, or alternatively, the codec may determine whether the request is associated with a critical audio path based at least in part on a flag associated with the request. For example, the request may include at least one bit that indicates whether the request is critical. Additionally, or alternatively, the codec may determine whether the request is associated with a critical audio path based at least in part on a key associated with the request. For example, the request may include a sequence (or another type of data) that is generated using a private key. Accordingly, the TDM block may use the private key to generate the sequence and thus indicate when the request is critical. Any of the factors described above may be combined. For example, the codec may determine that the request is associated with a critical audio path when the source indicates an audio port that is critical and when the request includes the flag.

As shown by reference number 515, the codec may transmit, and the TDM block may receive, an indication of an assigned hardware pin based at least in part on whether the request is associated with a critical audio path. For example, the codec may reserve a first set of hardware pins for critical audio paths while a second set of hardware pins may be used for other audio paths. The first set of hardware pins and the second set of hardware pins may be preconfigured (e.g., hard-wired or otherwise programmed into the codec). Alternatively, the codec may dynamically reserve the first set of hardware pins and assign remaining hardware pins to the second set of hardware pins. For example, the codec may receive input from the host system indicating a quantity of critical audio paths and reserve the first set of hardware pins based on the quantity. In some implementations, the first set of hardware pins may be further selected based on a floor (e.g., always having at least one, two, or more hardware pins reserved for critical audio) and/or a ceiling (e.g., having no more than three, four, or more hardware pins reserved for critical audio).

Accordingly, the codec may select the assigned hardware pin from the first set of hardware pins when the request is critical and may select the assigned hardware pin from the second set of hardware pin when the request is not critical. As shown in FIG. 5B and by reference number 520a, the user device may transmit, and the DSP may receive, input associated with an audio session ID. For example, the OS of, or an application executed on, the user device may buffer audio for playback, and the OS of the user device may transmit the input (e.g., digitally encoding the buffered audio) in response to detecting the audio in the buffer.

The user device may transmit the input directly to the DSP (e.g., when the host system provides the OS of the user device access to the DSP). Alternatively, as shown by reference number 520b, the user device may transmit, and the host system may receive, the input associated with the audio session ID. Accordingly, the host system may transmit, and the DSP may receive, digital input based on the input from the user device, as shown by reference number 525. The host system may forward the input from the user device or may generate new packets for transmitting to the DSP using information included in the input from the user device.

Additionally, or alternatively, the host system may transmit, and the DSP may receive, input associated with the audio session ID. For example, the OS of, or an application executed on, the host system may buffer audio for playback, and the OS of the host system may transmit the input (e.g., digitally encoding the buffered audio) in response to detecting the audio in the buffer.

As shown by reference number 530, the DSP may process the input (from the user device and/or the host system) to generate a digital output stream (comprising output signals) and transmit the digital output stream to the TDM block. Further, as shown by reference number 535, the TDM block may combine digital output streams from the DSP, process the combined streams to generate an analog output stream (comprising an output audio stream), and transmit the analog output stream to the codec. As shown by reference number 540, the codec may decode the analog output stream to generate output analog signals and transmit the output analog signals to the speaker, which will generate audio waves from the output analog signals.

By using techniques as described in connection with FIGS. 5A-5B, security is increased because critical audio paths are protected by the codec. As a result, power and processing resources at the audio chain are conserved because bad actors are prevented from needlessly occupying hardware pins in order to override critical audio.

Examples 300, 400, and/or 500 may be combined. For example, the DSP may reserve audio session IDs in combination with the TDM block reserving audio ports and/or the codec reserving hardware pins. In another example, the TDM block may reserve audio ports in combination with the codec reserving hardware pins and/or the DSP reserving audio session IDs.

As indicated above, FIGS. 5A-5B are provided as an example. Other examples may differ from what is described with respect to FIGS. 5A-5B.

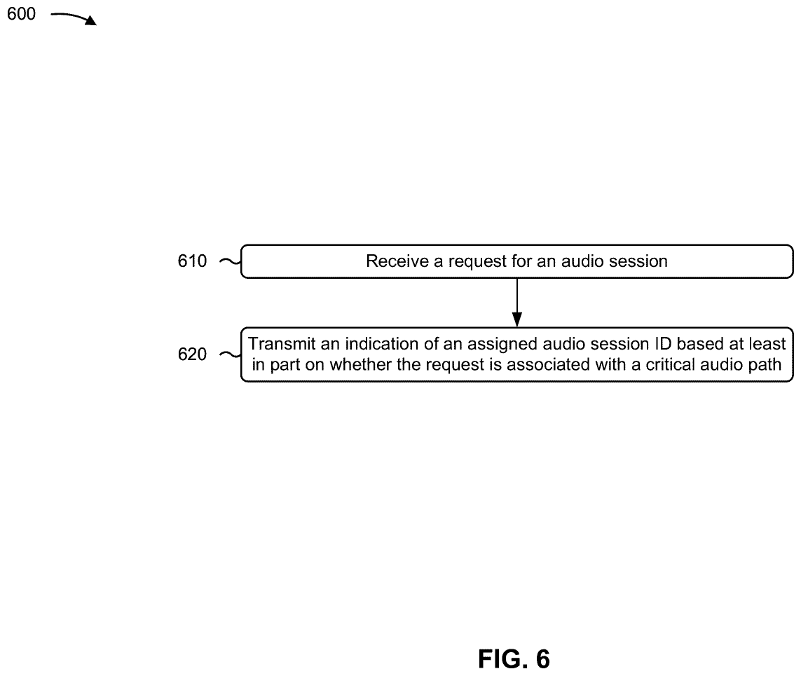

FIG. 6 is a flowchart of an example process 600 associated with securing critical audio paths. In some implementations, one or more process blocks of FIG. 6 are performed by an audio output device (e.g., the audio output device 120). In some implementations, one or more process blocks of FIG. 6 are performed by another device or a group of devices separate from or including the audio output device, such as a user device (e.g., the user device 110) and/or a host system (e.g., the host system 130). Additionally, or alternatively, one or more process blocks of FIG. 6 may be performed by one or more components of device 200, such as processor 210, memory 215, storage component 220, input component 225, output component 230, communication interface 235, and/or DSP 245.

As shown in FIG. 6, process 600 may include receiving a request for an audio session (block 610). For example, the audio output device (e.g., using DSP 245) may receive a request for an audio session, as described herein.

As further shown in FIG. 6, process 600 may include transmitting an indication of an assigned audio session ID based at least in part on whether the request is associated with a critical audio path (block 620). For example, the audio output device (e.g., using DSP 245) may transmit an indication of an assigned audio session ID based at least in part on whether the request is associated with a critical audio path, as described herein.

Process 600 may include additional implementations, such as any single implementation or any combination of implementations described below and/or in connection with one or more other processes described elsewhere herein.

In a first implementation, process 600 includes determining (e.g., using DSP 245) whether the request is associated with a critical audio path based at least in part on a source associated with the request, a flag associated with the request, or a key associated with the request.

In a second implementation, alone or in combination with the first implementation, a first set of audio session IDs are associated with critical audio paths, a second set of audio session IDs are associated with other audio paths, and the assigned audio session ID is selected from the first set of audio session IDs or the second set of audio session IDs.

In a third implementation, alone or in combination with one or more of the first and second implementations, process 600 includes reserving (e.g., using DSP 245) the first set of audio session IDs based at least in part on a quantity of critical audio paths, and assigning (e.g., using DSP 245) remaining audio session IDs to the second set of audio session IDs.

In a fourth implementation, alone or in combination with one or more of the first through third implementations, process 600 includes receiving (e.g., using DSP 245) input associated with the assigned audio session ID, and processing (e.g., using DSP 245) the input to generate output signals.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

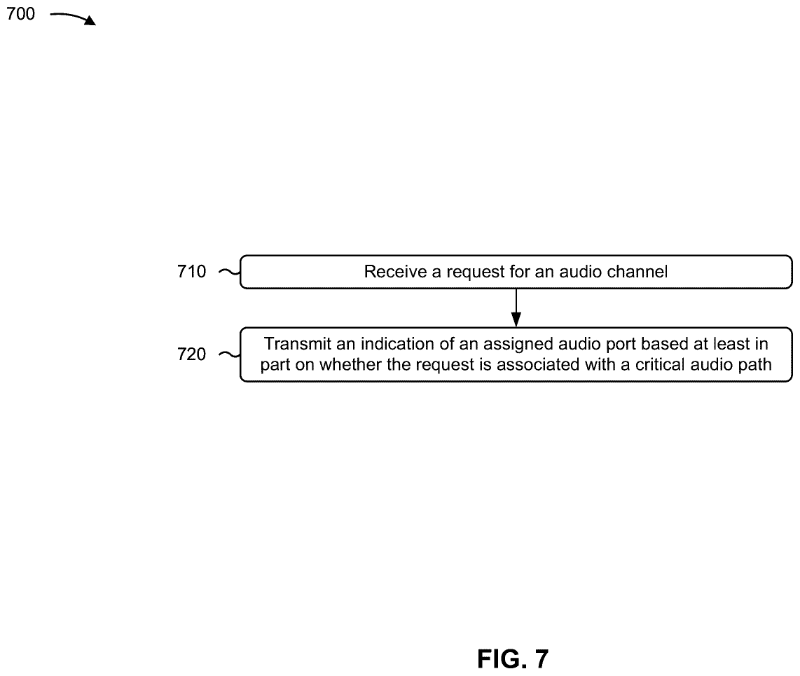

FIG. 7 is a flowchart of an example process 700 associated with securing critical audio paths. In some implementations, one or more process blocks of FIG. 7 are performed by an audio output device (e.g., the audio output device 120). In some implementations, one or more process blocks of FIG. 6 are performed by another device or a group of devices separate from or including the audio output device, such as a user device (e.g., the user device 110) and/or a host system (e.g., the host system 130). Additionally, or alternatively, one or more process blocks of FIG. 6 may be performed by one or more components of device 200, such as processor 210, memory 215, storage component 220, input component 225, output component 230, communication interface 235, and/or TDM block 250.

As shown in FIG. 7, process 700 may include receiving a request for an audio channel (block 710). For example, the audio output device (e.g., using TDM block 250) may receive a request for an audio channel, as described herein.

As further shown in FIG. 7, process 700 may include transmitting an indication of an assigned audio port based at least in part on whether the request is associated with a critical audio path (block 720). For example, the audio output device (e.g., using TDM block 250) may transmit an indication of an assigned audio port based at least in part on whether the request is associated with a critical audio path, as described herein.

Process 700 may include additional implementations, such as any single implementation or any combination of implementations described below and/or in connection with one or more other processes described elsewhere herein.

In a first implementation, process 700 includes determining (e.g., using TDM block 250) whether the request is associated with a critical audio path based at least in part on a source associated with the request, a flag associated with the request, or a key associated with the request.

In a second implementation, alone or in combination with the first implementation, a first set of audio ports are associated with critical audio paths, a second set of audio ports are associated with other audio paths, and the assigned audio port is selected from the first set of audio ports or the second set of audio ports.

In a third implementation, alone or in combination with one or more of the first and second implementations, process 700 includes reserving (e.g., using TDM block 250) the first set of audio ports based at least in part on a quantity of critical audio paths, and assigning (e.g., using TDM block 250) remaining audio ports to the second set of audio ports.

In a fourth implementation, alone or in combination with one or more of the first through third implementations, process 700 includes receiving (e.g., using TDM block 250) input associated with the assigned audio port, and processing (e.g., using TDM block 250) the input to generate an output audio stream.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

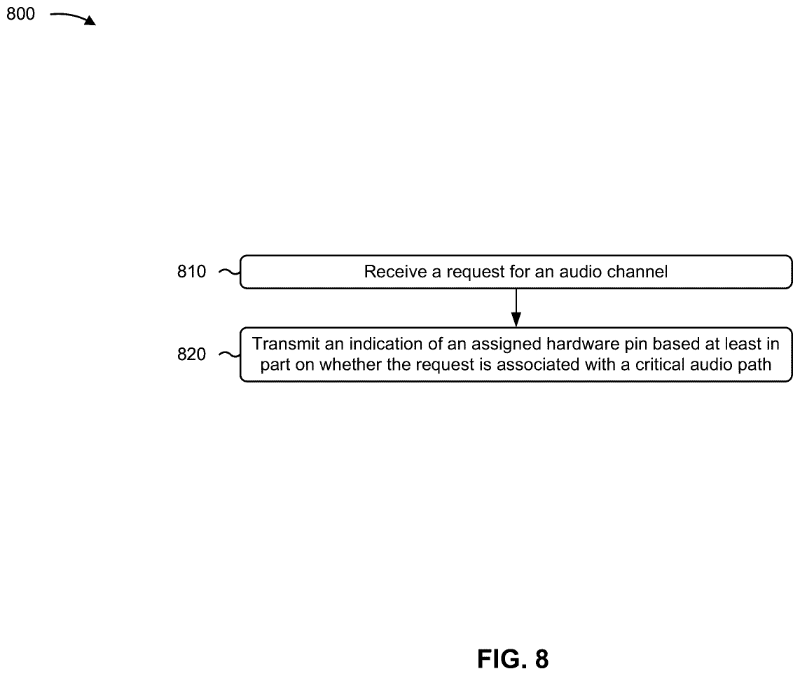

FIG. 8 is a flowchart of an example process 800 associated with securing critical audio paths. In some implementations, one or more process blocks of FIG. 8 are performed by an audio output device (e.g., the audio output device 120). In some implementations, one or more process blocks of FIG. 6 are performed by another device or a group of devices separate from or including the audio output device, such as a user device (e.g., the user device 110) and/or a host system (e.g., the host system 130). Additionally, or alternatively, one or more process blocks of FIG. 6 may be performed by one or more components of device 200, such as processor 210, memory 215, storage component 220, input component 225, output component 230, communication interface 235, and/or codec 255.

As shown in FIG. 8, process 800 may include receiving a request for an audio channel (block 810). For example, the audio output device (e.g., using codec 255) may receive a request for an audio channel, as described herein.

As further shown in FIG. 8, process 800 may include transmitting an indication of an assigned hardware pin based at least in part on whether the request is associated with a critical audio path (block 820). For example, the audio output device (e.g., using codec 255) may transmit an indication of an assigned hardware pin based at least in part on whether the request is associated with a critical audio path, as described herein.

Process 800 may include additional implementations, such as any single implementation or any combination of implementations described below and/or in connection with one or more other processes described elsewhere herein.

In a first implementation, process 800 includes determining (e.g., using codec 255) whether the request is associated with a critical audio path based at least in part on a source associated with the request, a flag associated with the request, or a key associated with the request.

In a second implementation, alone or in combination with the first implementation, a first set of hardware pins are associated with critical audio paths, a second set of hardware pins are associated with other audio paths, and the assigned hardware pin is selected from the first set of hardware pins or the second set of hardware pins.

In a third implementation, alone or in combination with one or more of the first and second implementations, process 800 includes reserving (e.g., using codec 255) the first set of hardware pins based at least in part on a quantity of critical audio paths, and assigning (e.g., using codec 255) remaining hardware pins to the second set of hardware pins.

In a fourth implementation, alone or in combination with one or more of the first through third implementations, process 800 includes receiving (e.g., using codec 255) input on the assigned hardware pin, and processing (e.g., using codec 255) the input to generate output analog signals.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A method performed by an audio digital signal processor (DSP), comprising: receiving a request for an audio session; and transmitting an indication of an assigned audio session identity (ID) based at least in part on whether the request is associated with a critical audio path.

Aspect 2: The method of Aspect 1, further comprising: determining whether the request is associated with a critical audio path based at least in part on a source associated with the request, a flag associated with the request, or a key associated with the request.

Aspect 3: The method of any of Aspects 1 through 2, wherein a first set of audio session IDs are associated with critical audio paths, a second set of audio session IDs are associated with other audio paths, and the assigned audio session ID is selected from the first set of audio session IDs or the second set of audio session IDs.

Aspect 4: The method of Aspect 3, further comprising: reserving the first set of audio session IDs based at least in part on a quantity of critical audio paths; and assigning remaining audio session IDs to the second set of audio session IDs.

Aspect 5: The method of any of Aspects 1 through 4, further comprising: receiving input associated with the assigned audio session ID; and processing the input to generate output signals.

Aspect 6: A method performed by a time division multiplex (TDM) block, comprising: receiving a request for an audio channel; and transmitting an indication of an assigned audio port based at least in part on whether the request is associated with a critical audio path.

Aspect 7: The method of Aspect 6, further comprising: determining whether the request is associated with a critical audio path based at least in part on a source associated with the request, a flag associated with the request, or a key associated with the request.

Aspect 8: The method of any of Aspects 6 through 7, wherein a first set of audio ports are associated with critical audio paths, a second set of audio ports are associated with other audio paths, and the assigned audio port is selected from the first set of audio ports or the second set of audio ports.

Aspect 9: The method of Aspect 8, further comprising: reserving the first set of audio ports based at least in part on a quantity of critical audio paths; and assigning remaining audio ports to the second set of audio ports.

Aspect 10: The method of any of Aspects 6 through 9, further comprising: receiving input associated with the assigned audio port; and processing the input to generate an output audio stream.

Aspect 11: A method performed by codec hardware, comprising: receiving a request for an audio channel; and transmitting an indication of an assigned hardware pin based at least in part on whether the request is associated with a critical audio path.

Aspect 12: The method of Aspect 11, further comprising: determining whether the request is associated with a critical audio path based at least in part on a source associated with the request, a flag associated with the request, or a key associated with the request.

Aspect 13: The method of any of Aspects 11 through 12, wherein a first set of hardware pins are associated with critical audio paths, a second set of hardware pins are associated with other audio paths, and the assigned hardware pin is selected from the first set of hardware pins or the second set of hardware pins.

Aspect 14: The method of Aspect 13, further comprising: reserving the first set of hardware pins based at least in part on a quantity of critical audio paths; and assigning remaining hardware pins to the second set of hardware pins.

Aspect 15: The method of any of Aspects 11 through 14, further comprising: receiving input on the assigned hardware pin; and processing the input to generate output analog signals.

Aspect 16: A method performed by an audio system, comprising: receiving, at an audio digital signal processor (DSP), a request for an audio session; transmitting, by the audio DSP, an indication of an assigned audio session identity (ID) based at least in part on whether the request for the audio session is associated with a critical audio path; receiving, at a time division multiplex (TDM) block, a request for an audio channel; transmitting, by the TDM block, an indication of an assigned audio port based at least in part on whether the request for the audio channel is associated with a critical audio path; receiving, at codec hardware, a request for an audio pin; and transmitting, by the codec hardware, an indication of an assigned hardware pin based at least in part on whether the request for the audio pin is associated with a critical audio path.

Aspect 17: The method of Aspect 16, further comprising: determining whether the request is associated with a critical audio path based at least in part on a source associated with the request, a flag associated with the request, or a key associated with the request.

Aspect 18: The method of any of Aspects 16 through 17, wherein a first set of audio session IDs are associated with critical audio paths, a second set of audio session IDs are associated with other audio paths, and the assigned audio session ID is selected from the first set of audio session IDs or the second set of audio session IDs.

Aspect 19: The method of Aspect 18, further comprising: reserving the first set of audio session IDs based at least in part on a quantity of critical audio paths; and assigning remaining audio session IDs to the second set of audio session IDs.

Aspect 20: The method of any of Aspects 16 through 19, further comprising: receiving, at the audio DSP, input associated with the assigned audio session ID; and processing, by the audio DSP, the input to generate output signals.

Aspect 21: The method of any of Aspects 16 through 20, wherein a first set of audio ports are associated with critical audio paths, a second set of audio ports are associated with other audio paths, and the assigned audio port is selected from the first set of audio ports or the second set of audio ports.

Aspect 22: The method of Aspect 21, further comprising: reserving the first set of audio ports based at least in part on a quantity of critical audio paths; and assigning remaining audio ports to the second set of audio ports.

Aspect 23: The method of any of Aspects 16 through 22, further comprising: receiving, at the TDM block, input associated with the assigned audio port; and processing, by the TDM block, the input to generate an output audio stream.

Aspect 24: The method of any of Aspects 16 through 23, wherein a first set of hardware pins are associated with critical audio paths, a second set of hardware pins are associated with other audio paths, and the assigned hardware pin is selected from the first set of hardware pins or the second set of hardware pins.

Aspect 25: The method of Aspect 24, further comprising: reserving the first set of hardware pins based at least in part on a quantity of critical audio paths; and assigning remaining hardware pins to the second set of hardware pins.

Aspect 26: The method of any of Aspects 16 through 25, further comprising: receiving, at the codec hardware, input on the assigned hardware pin; and processing, by the codec hardware, the input to generate output analog signals.

Aspect 27: An apparatus for audio generation at a device, comprising a processor; memory coupled with the processor; and instructions stored in the memory and executable by the processor to cause the apparatus to perform the method of one or more of Aspects 1-5.

Aspect 28: A device for audio generation, comprising a memory and one or more processors coupled to the memory, the one or more processors configured to perform the method of one or more of Aspects 1-5.

Aspect 29: An apparatus for audio generation, comprising at least one means for performing the method of one or more of Aspects 1-5.

Aspect 30: A non-transitory computer-readable medium storing code for audio generation, the code comprising instructions executable by a processor to perform the method of one or more of Aspects 1-5.

Aspect 31: A non-transitory computer-readable medium storing a set of instructions for audio generation, the set of instructions comprising one or more instructions that, when executed by one or more processors of a device, cause the device to perform the method of one or more of Aspects 1-5.

Aspect 32: An apparatus for audio generation at a device, comprising a processor; memory coupled with the processor; and instructions stored in the memory and executable by the processor to cause the apparatus to perform the method of one or more of Aspects 6-10.

Aspect 33: A device for audio generation, comprising a memory and one or more processors coupled to the memory, the one or more processors configured to perform the method of one or more of Aspects 6-10.

Aspect 34: An apparatus for audio generation, comprising at least one means for performing the method of one or more of Aspects 6-10.

Aspect 35: A non-transitory computer-readable medium storing code for audio generation, the code comprising instructions executable by a processor to perform the method of one or more of Aspects 6-10.

Aspect 36: A non-transitory computer-readable medium storing a set of instructions for audio generation, the set of instructions comprising one or more instructions that, when executed by one or more processors of a device, cause the device to perform the method of one or more of Aspects 6-10.

Aspect 37: An apparatus for audio generation at a device, comprising a processor; memory coupled with the processor; and instructions stored in the memory and executable by the processor to cause the apparatus to perform the method of one or more of Aspects 11-15.

Aspect 38: A device for audio generation, comprising a memory and one or more processors coupled to the memory, the one or more processors configured to perform the method of one or more of Aspects 11-15.

Aspect 39: An apparatus for audio generation, comprising at least one means for performing the method of one or more of Aspects 11-15.

Aspect 40: A non-transitory computer-readable medium storing code for audio generation, the code comprising instructions executable by a processor to perform the method of one or more of Aspects 11-15.

Aspect 41: A non-transitory computer-readable medium storing a set of instructions for audio generation, the set of instructions comprising one or more instructions that, when executed by one or more processors of a device, cause the device to perform the method of one or more of Aspects 11-15.

Aspect 42: An apparatus for audio generation at a device, comprising a processor; memory coupled with the processor; and instructions stored in the memory and executable by the processor to cause the apparatus to perform the method of one or more of Aspects 16-26.

Aspect 43: A device for audio generation, comprising a memory and one or more processors coupled to the memory, the one or more processors configured to perform the method of one or more of Aspects 16-26.

Aspect 44: An apparatus for audio generation, comprising at least one means for performing the method of one or more of Aspects 16-26.

Aspect 45: A non-transitory computer-readable medium storing code for audio generation, the code comprising instructions executable by a processor to perform the method of one or more of Aspects 16-26.

Aspect 46: A non-transitory computer-readable medium storing a set of instructions for audio generation, the set of instructions comprising one or more instructions that, when executed by one or more processors of a device, cause the device to perform the method of one or more of Aspects 16-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for audio generation at an audio digital signal processor (DSP), comprising:
a memory; and
one or more processors, coupled to the memory, configured to:
receive a request for an audio session; and
transmit an indication of an assigned audio session identity (ID) based at least in part on whether the request is associated with a critical audio path.

2. The apparatus of claim 1, wherein the one or more processors are further configured to:
determine whether the request is associated with a critical audio path based at least in part on a source associated with the request, a flag associated with the request, or a key associated with the request.

3. The apparatus of claim 1, wherein a first set of audio session IDs are associated with critical audio paths, a second set of audio session IDs are associated with other audio paths, and the assigned audio session ID is selected from the first set of audio session IDs or the second set of audio session IDs.

4. The apparatus of claim 3, wherein the one or more processors are further configured to:
reserve the first set of audio session IDs based at least in part on a quantity of critical audio paths; and
assign remaining audio session IDs to the second set of audio session IDs.

5. The apparatus of claim 1, wherein the one or more processors are further configured to:
receive input associated with the assigned audio session ID; and
process the input to generate output signals.

6. An apparatus for audio generation by a time division multiplex (TDM) block, comprising:
a memory; and
one or more processors, coupled to the memory, configured to:
receive a request for an audio channel; and
transmit an indication of an assigned audio port based at least in part on whether the request is associated with a critical audio path.

7. The apparatus of claim 6, wherein the one or more processors are further configured to:
determine whether the request is associated with a critical audio path based at least in part on a source associated with the request, a flag associated with the request, or a key associated with the request.

8. The apparatus of claim 6, wherein a first set of audio ports are associated with critical audio paths, a second set of audio ports are associated with other audio paths, and the assigned audio port is selected from the first set of audio ports or the second set of audio ports.

9. The apparatus of claim 8, wherein the one or more processors are further configured to:
reserve the first set of audio ports based at least in part on a quantity of critical audio paths; and
assign remaining audio ports to the second set of audio ports.

10. The apparatus of claim 6, wherein the one or more processors are further configured to:
receive input associated with the assigned audio port; and
process the input to generate an output audio stream.

11. An apparatus for audio generation at codec hardware, comprising:
a memory; and
one or more processors, coupled to the memory, configured to:
receive a request for an audio channel; and
transmit an indication of an assigned hardware pin based at least in part on whether the request is associated with a critical audio path.

12. The apparatus of claim 11, wherein the one or more processors are further configured to:
determine whether the request is associated with a critical audio path based at least in part on a source associated with the request, a flag associated with the request, or a key associated with the request.

13. The apparatus of claim 11, wherein a first set of hardware pins are associated with critical audio paths, a second set of hardware pins are associated with other audio paths, and the assigned hardware pin is selected from the first set of hardware pins or the second set of hardware pins.

14. The apparatus of claim 13, wherein the one or more processors are further configured to:
reserve the first set of hardware pins based at least in part on a quantity of critical audio paths; and
assign remaining hardware pins to the second set of hardware pins.

15. The apparatus of claim 11, wherein the one or more processors are further configured to:
receive input on the assigned hardware pin; and
process the input to generate output analog signals.

16. An apparatus for audio generation at an audio system, comprising:
a memory; and
one or more processors, coupled to the memory, configured to:
receive, at an audio digital signal processor (DSP), a request for an audio session;
transmit, by the audio DSP, an indication of an assigned audio session identity (ID) based at least in part on whether the request for the audio session is associated with a critical audio path;
receive, at a time division multiplex (TDM) block, a request for an audio channel;
transmit, by the TDM block, an indication of an assigned audio port based at least in part on whether the request for the audio channel is associated with a critical audio path;
receive, at codec hardware, a request for an audio pin; and
transmit, by the codec hardware, an indication of an assigned hardware pin based at least in part on whether the request for the audio pin is associated with a critical audio path.

17. The apparatus of claim 16, wherein the one or more processors are further configured to:
determine whether the request is associated with a critical audio path based at least in part on a source associated with the request, a flag associated with the request, or a key associated with the request.

18. The apparatus of claim 16, wherein a first set of audio session IDs are associated with critical audio paths, a second set of audio session IDs are associated with other audio paths, and the assigned audio session ID is selected from the first set of audio session IDs or the second set of audio session IDs.

19. The apparatus of claim 18, wherein the one or more processors are further configured to:
reserve the first set of audio session IDs based at least in part on a quantity of critical audio paths; and
assign remaining audio session IDs to the second set of audio session IDs.

20. The apparatus of claim 16, wherein the one or more processors are further configured to:
receive, at the audio DSP, input associated with the assigned audio session ID; and
process, by the audio DSP, the input to generate output signals.

21. The apparatus of claim 16, wherein a first set of audio ports are associated with critical audio paths, a second set of audio ports are associated with other audio paths, and the assigned audio port is selected from the first set of audio ports or the second set of audio ports.

22. The apparatus of claim 21, wherein the one or more processors are further configured to:
reserve the first set of audio ports based at least in part on a quantity of critical audio paths; and
assign remaining audio ports to the second set of audio ports.

23. The apparatus of claim 16, wherein the one or more processors are further configured to:
receive, at the TDM block, input associated with the assigned audio port; and
process, by the TDM block, the input to generate an output audio stream.

24. The apparatus of claim 16, wherein a first set of hardware pins are associated with critical audio paths, a second set of hardware pins are associated with other audio paths, and the assigned hardware pin is selected from the first set of hardware pins or the second set of hardware pins.

25. The apparatus of claim 24, wherein the one or more processors are further configured to:
reserve the first set of hardware pins based at least in part on a quantity of critical audio paths; and
assign remaining hardware pins to the second set of hardware pins.

26. The apparatus of claim 16, wherein the one or more processors are further configured to:
receive, at the codec hardware, input on the assigned hardware pin; and
process, by the codec hardware, the input to generate output analog signals.
